(19) United States
(12) Patent Application Publication
(10) Pub. No.: US 2013/0270836 A1
(43) Pub. Date: Oct. 17, 2013

(54) Gravitational Electric Power Plant Technology

(71) Applicant: Shafi Quraishy, Dubai (AE)

(72) Inventor: Shafi Quraishy, Dubai (AE)

(21) Appl. No.: 13/996,085

(22) PCT Filed: Dec. 23, 2011
(86) PCT No.: PCT/IN2011/000887

§ 371 Date: Jun. 20, 2013

(30) Foreign Application Priority Data
Dec. 24, 2010 (IN) 3952/CHE/2010

(51) Int. Cl. F03G 3/00

(52) U.S. Cl. CPC F03G 3/00
USPC 290/1 A; 185/27; 185/32

(57) ABSTRACT

An apparatus, system and methods that on the one hand, maximise work done by gravity, by allowing free fall of an object with a heavy mass to harness energy and output therefrom, and on the other, maximises efficiency by counterbalancing this heavy mass by another similar mass such that only the net difference of the said two masses needs to be worked upon by input power mechanisms in order to lift the fallen object back up to its original position, along the direction of gravity or otherwise, to repeat the cycle. A plurality of such units are employed in synchronised tandem to maintain a steady RPM of the gear/flywheel/shaft connecting a high output generator. Still further, auxiliary energy generation mechanisms to further augment efficiency of the system are disclosed.

### FIELD OF THE INVENTION

This invention relates to the field of harnessing gravitational force and to the conversion of the work done by gravitational force into other forms of energy and/or work. More particularly this invention relates to generation of electrical energy by harnessing gravitational force either solely or in combination with other forms of energy (renewable or non-renewable), with special focus on resource-economy, minimal pollution and externalities.

### BACKGROUND OF THE INVENTION

The industrial revolution radically influenced almost every aspect of human life and in pursuit of sophistication and advancement, man's dependencies not only shifted, but also increased exponentially. Today machines created by man govern his life—his households, businesses, transport, agricultural output, food processing, warfare, economy, as well as dictate the quality of his future. Since all machines need power (energy) to process their input, demand for power too has exponentially increased and today the ability to generate enough power is among the key factors that decide a country's stature in the international economic and political arena. Focus until recent decades had been on conventional non-renewable resources (Fossil fuels such as coal, petroleum, and natural gas, and later, types of nuclear power such as from radioactive uranium, and certain aquifers) to meet power demands. But our power plants and heating-cooling-cooking-burning practices are now producing more greenhouse gases than we can tolerate to maintain a stable climate. The international climate science community cautions us to drastically cut our carbon emissions. Further, we are now approaching peak oil and gas production, in which half the amount of total known global supply has already been used, with steadily increasing prices to come; and “clean coal”, “sustainable biomass”, “safe nuclear” and other such clichés seem mere illusions. The only remaining choices quoted by the international scientific community for our energy future are the ‘Renewables’—hydropower, geothermal, biomass, solar thermal, solar electric, wind, tides, waves, ocean-thermal-gradients, and new, unconventional technologies such as vacuum (zero-point) energy, low-temperature nonradioactive nuclear reactions (“cold” fusion), and advanced hydrogen and water chemistries.

Existing nonrenewable and renewable energy generation technologies and their contribution to the global energy is approximately thus; NONRENEWABLES (93%);—1. Combustion of petroleum-based fuels (39%), 2. Combustion of natural gas (24%), 3. Combustion of coal and its derivatives (24%), 4. Hydrogen derived from petroleum, natural gas, or coal, 5. Uranium and plutonium fission-based nuclear reactors that are highly radioactive. (5%), 6. “Hot fusion”: RENEWABLES (7%);—7. Wind-based generation systems (0.2%), 8. Solar-based heating and power generation systems (0.1%), 9. Geothermal-based heating and power generation systems (0.4%), 10. Biofuels (ethanol and biodiesel) (1%), 11. Biomass combustion (mostly wood chips) (2%), 12. Fuel cells, 13. Anaerobic digestion of waste to biogas, 14. Conventional hydroelectric generators (3%).

Another renewable resource that remains largely untapped is gravity, which is clean, free and ubiquitous. Several experiments and inventions using gravity form part of literature relevant to the power sector. However, one common approach taken by many an inventor is to build a self sustaining machine using gravity, to generate power—which may seem feasible in theory, but isn't so practice—especially in the context of producing substantial amounts of power that can be harvested to run other machines/appliances. This is primarily due to the fact that the work done by gravity on a given (self sustaining) machine is barely enough to sustain itself, and the prospects of additional power generation are therefore unrealistic. For instance US20090115195, a gravity power generation mechanism seeks to run the power generation unit by running a series of single-directional-swing arms that tend to stretch outward on only one side, as they circle the said unit, so as to produce a larger positive torque (purportedly due to the outstretched arms on one side), that would impel and sustain continuous rotational motion of that unit. This however is not true in practice since a greater number of collapsed arms collect on the opposite side and cancel out the positive torque created by the fewer outstretched ones. In Indian Patent No. 207600 (649/MUM/2004), the claimed apparatus seeks to use gravitational force exerted on a falling object suspended by a rope and pulley, to rotate a fly wheel which is said to store the rotational kinetic energy, and which in turn is said to lift the (fallen) object upward; and this cycle of alternate upward-downward movement of the said weight is claimed to be used to rotate a dynamo shaft to generate electricity. This is again not a sustainable design for efficient power generation since it contradicts the 2^{nd} law of thermodynamics that states that some energy in a system is always lost (including during transmission), and therefore a machine cannot make more energy than it uses or even enough to keep itself operating indefinitely.

It is therefore imperative that an external force be employed to sustain additional work done by a machine, especially one that uses gravity. Therefore in U.S. Pat. No. 6,445,078, an elevated water reservoir fills a plurality of containers that travel downward under the weight of the water and this ‘controlled’ gravity influenced movement is made to drive a generator, while the said containers after reaching down, are emptied and carried back up by an ad hoc powered mechanism. In U.S. Pat. No. 5,905,312 too, a similar concept is applied wherein water or other fluid from an elevated reservoir feeds secondary tanks that glide under the influence of gravity along a controlled downward path and are emptied into another floor reservoir. This downward gravity induced motion is harnessed to rotate a generator shaft with the help of gears. Water emptied by the said secondary tanks is pumped back into the elevated tank by an ad hoc powered pump. In these systems however, since the downward movement is ‘controlled’ and is not a free fall, the entire work done by gravity on the load is not available to be harnessed, which directly affects the efficiency of the said systems. Besides, factors including the time taken to fill water into each container/tank, the rate at which water/fluid is fed back into the reservoir, and the maximum feasible size of each container/tank etc., limit the scalability of the set-up and are not ideal for very high power generation requirements such as those that power a township or even a reasonably large industrial installation. In U.S. Pat. No. 8,011,182, US20110179784 and in US20110162356, gravity acts on a series of buckets fastened to a chain or belt, that descend downward in a liquid medium due to their mass/weight (gravity). Once they reach the bottom, they are filled with gas or other lighter fluid/medium, that renders them buoyant thereby causing their ascent (upward), and upon reaching the top the gas is released out of the buckets. This cyclic upward-downward movement is used to run a generator shaft to produce electricity. Here again, the velocity of descent, and the rate at which gas is refilled into each bucket, the largest feasible size of a bucket, and the torque that can be so created etc., limit the scalability of the invention which cannot be used for high power generation requirements.

It is therefore apparent from prior art (inventions) that gravity based models thus far have not been able to cater to large or even medium scale power requirements. Gravity being free, perennial, ubiquitous, ecologically safe and above all—directly proportional to product of the mass of the object in question (—promising remarkable efficiency), and independent of climate, season, weather, wind, sunshine, tide, rain, geography or other resources etc., presents an avenue to an urgent as well as long felt need for a viable solution that is safe and sustainable, and that effectively harnesses gravitational force and efficiently converts the work done by gravity into other forms of energy, particularly electrical energy, especially at a very large scale.

This inventor has developed an apparatus, system and method/s that effectively harnesses gravitational force and efficiently convert work done by gravity into other forms of energy, especially electrical energy, and that is versatile and almost illimitable as to its scalability.

### OBJECTS OF THE INVENTION

It is therefore the main object of this invention to effectively harness work done by gravitational force, and to efficiently convert the same to other forms of energy and/or work, more particularly electrical energy, in an economical, eco-friendly and safe manner.

It is another main object of this invention to design and implement an apparatus, system and method/s that harness and convert gravitational force so as to generate large, medium and small scale electric power, whereby the aspect of scalability is almost illimitable, applicable anywhere and around the year.

It is another main object of this invention to enhance the effectiveness of harnessing gravitational energy.

It is another main object of this invention to enhance the efficiency of conversion of gravitational energy to other forms of energy, especially electrical energy.

It is another main object of this invention to allow for a heavy mass to fall freely under the influence of gravity, so as to increase the total work done, for harnessing and conversion; and to provide for controlling its fall and for lifting the said heavy mass back up, by a counterbalancing means such that the net weight that is lifted is the difference between the two, thereby increasing efficiency of the system.

It is another object of this invention to optimise the number of units employed, with the distance and speed of the free fall of the object/s with heavy mass, whereby upward or downward movement of either the Main weight or the Counterweight in any given unit is passive and entirely driven by gravity alone, so as to achieve minimal input of power, and superlative efficiency.

It is yet another object of this invention to provide for auxiliary power generation mechanisms in the gravity power generation system to enhance overall out put of power generated and thereby enhance the efficiency of the system.

### STATEMENT AND SUMMARY OF THE INVENTION

According to this invention, there is therefore provided an apparatus, system/s and method/s that on the one hand, maximise work done by gravity, by allowing free fall of a an object with a heavy mass to harness energy and output therefrom, and on the other, maximises efficiency by counterbalancing this heavy mass by another similar mass such that only the net difference of the said two masses needs to be worked upon by input power mechanisms in order to lift the fallen object back up to its original position, along the direction of gravity or otherwise, to repeat the cycle. A plurality of such units are used in synchronised tandem to maintain a steady RPM of the gear/flywheel/shaft connecting a high output generator. Besides, this invention also envisages auxiliary energy generation mechanisms known in the art to further augment efficiency of the system; each such unit comprising; (i) A hollow vertical channel, erected above ground level, provided with at least two guide rails along its inner walls through which (ii) a Main-weight comprising (ii)(a) an upper component called the ‘Head’ made of a material of suitable mass and density, preferably Titanium, shaped preferably corresponding to the cross section of the channel and provided with means at its periphery, that conform with and slide through and along the said guide rails of the said vertical channel, and (ii)(b) a lower component being a vertical shaft made of a material of suitable mass and density, preferably Titanium, which bears teeth at least on one side of its length that engage a (iii) Main gear that in turn directly or through a flywheel and/or secondary gear/s, to rotate the (iv) Horizontal shaft of a generator, as the said vertical shaft moves downward with the falling Main weight due to the gravitational force. The said main gear is constructed like a free wheel so as to permit bi-directional engagement, and uni-directional rotation of the said Horizontal shaft of the generator, when the said vertical shaft moves downward.
(a) The upper said component (ii)(a) of the main weight is preferably (but not limited to) cylindrical, or cylindrical-oval, square-prism or such other shape corresponding to the said hollow vertical channel and depending on specific requirements of a project. For instance, where the project caters to large scale electricity generation wherein very heavy and large weight is used, it is preferable to use cylindrical, oval or square prism shape in order to accommodate a larger number of ropes to suspend the said weight. As the said main weight makes a downward freefall under the influence of gravity, its upper component or Head reaches the bottom of the hollow vertical channel where it is gradually halted with the help of (v) retarding/halting means that include but are not limited one or more of the following; Air Chamber/s, Air Pusher/s, spring/s, brakes, Electromagnet/s, Means that exert Lenz's force/s, Opposing movement of the Counterweight on the other side; and the Vertical shaft being the lower component of the said main weight enters a (vi) vertical subterranean hollow tube.

The said weight is suspended by (vii) ropes from a (viii) system of pulleys wherein the other ends of the said ropes are attached to (ix) a Counterweight, which is mounted on a (x) lift such that the said lift (along with the said counterweight) is suspended to slide upward and downward in (xi) a vertical frame erected parallel to the said hollow vertical channel, such that the direction of movement of the Main weight is opposite that of the counterweight which is as heavy as or marginally heavier or lighter than the main weight, depending upon the design of a given embodiment/version/variant of this invention.

The Counterweight that counter-balances the Main weight, is mounted on a powered Lift system to carry it upwards and downwards at predetermined speeds to synchronize the falling Main weight such that revolution of the horizontal shaft of the generator is kept constant. The said ropes in each unit run over a system of pulleys; each system comprising a plurality of rows of pulleys, designed to provide for auxiliary power generation so as to allow for mounting coils/magnets to produce electricity.

The synchronisation of upward-downward movements of the main weight and counterweight is executed with the help of (xii) sensors and signalling means to synchronize and control the velocity of the counterweight and hence that of the main weight of one or more units, so as to maintain a steady RPM of the generator shaft.

### BRIEF DESCRIPTION OF THE DRAWINGS

FIG. 1: Schematically depicts two units and their constituents, wherein the Main weight of one unit is in its free falling/dropping phase while that of the other unit stands hoisted, in synchronized tandem.

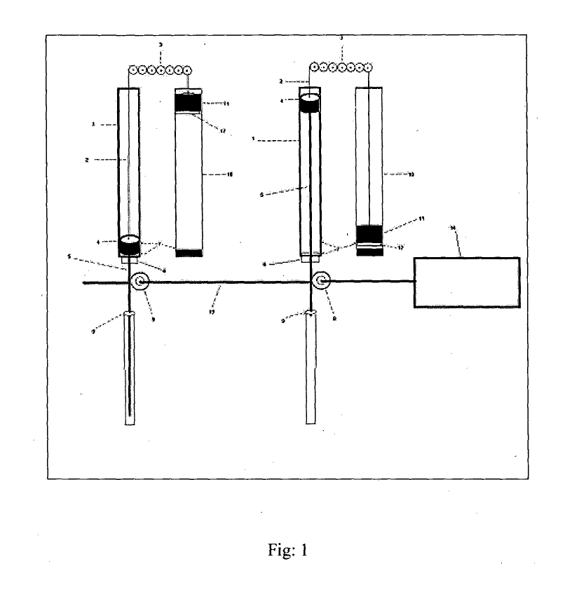

FIG. 2: Describes in perspective, the general layout for three units and their respective constituent parts.

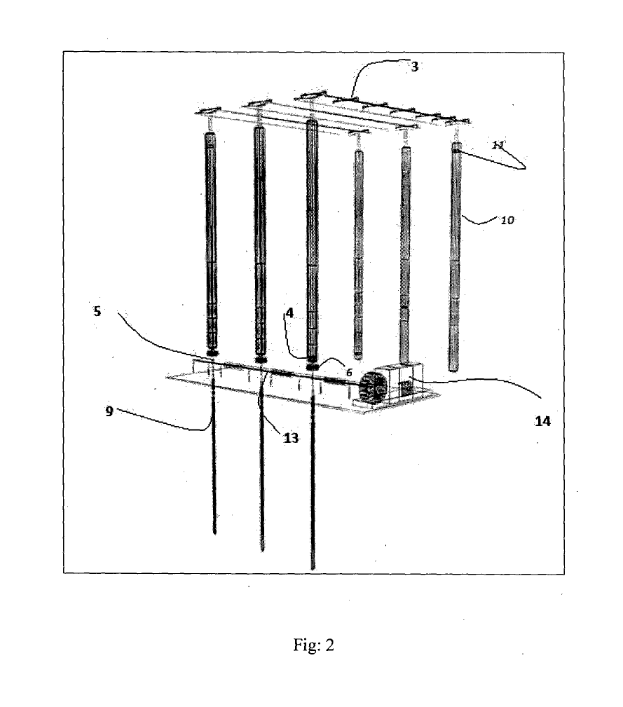

FIG. 3: Shows a close up focused on the Main weight as it drops to the bottom of the Hollow vertical channel while the retarding and halting means act on it.

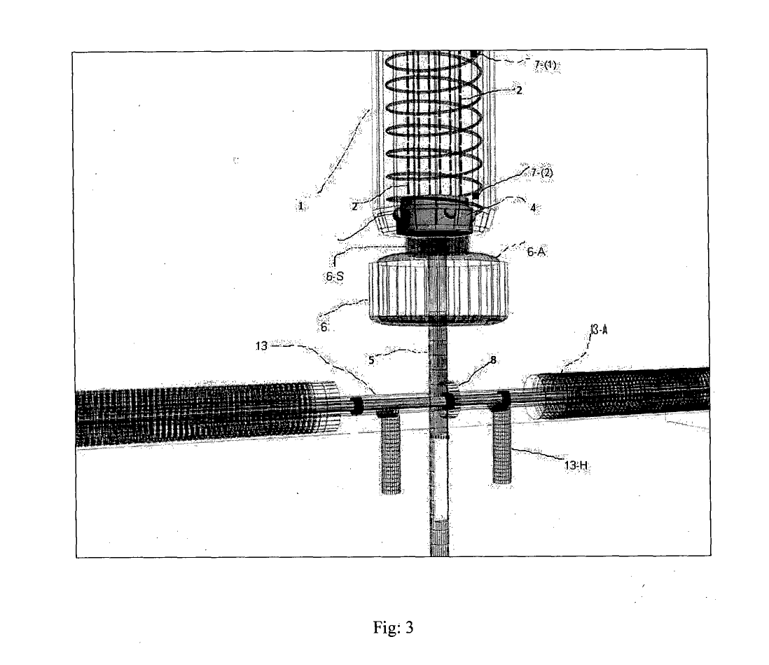

FIG. 4: Shows the Systems of pulleys and ropes suspending the Counterweight along with the Lift (as well as the Main weight—which is not shown), in perspective

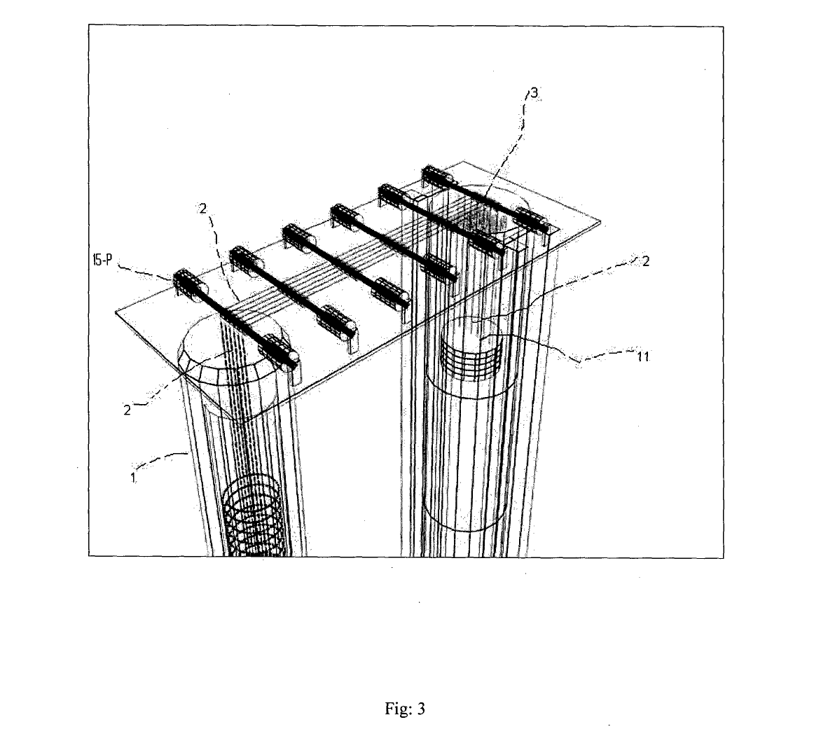

### INDEX OF ITEMS DESCRIBED IN THE DRAWINGS

1. Hollow vertical channel
2. Ropes
3. System of pulleys
4. Head of the Main-weight
5. Vertical shaft of the Main-weight
6. Halting and braking system within the Hollow vertical channel
6-A. Air pusher as part of braking system
6-S. Spring as part of braking system
7. Sensors and signaling means
7-(1). Sensor-1
7-(2). Sensor-2
8. Main gear
9. Vertical subterranean hollow tube
10. Vertical Frame
11. Counterweight
12. Lift
13. Horizontal shaft
13-A Auxiliary Power generating unit in System of Pulleys
13-H. Horizontal shaft holder
14. Generator
15. Auxiliary Power generating unit
15-P. Auxiliary Power generating unit in System of Pulleys

### DETAILED DESCRIPTION OF THE INVENTION

It is pertinent to mention that the description herein is meant to explain the design, construction and method/s by which the invention can be worked, more particularly and especially in a manner that applies to (but is not limited to) high capacity power generation plants, without limitation as to obvious alterations, modifications and adaptations of the parts, construction and method/s described; and that the diagrams/drawings herein are not drawn to scale but only serve to schematically explain the construction, working concept of the invention and represent the broad dimensions, shapes, spatial arrangement and inter-relationships of the parts, without limitation to their interchangeable or other obvious modifications and/or adaptations.

This invention anticipates material/s other than those specifically mentioned to describe the working embodiments, their various forms, adaptations and versions and various other metallic alloys and other combinations commonly used in the art for manufacture of power generation equipment.

Obvious and rather trivial details that do not warrant specific mention and which are known and obvious to a person skilled in the art are not mentioned and/or explained and/or drawn, while they are very much a part of this invention.

The description herein therefore shall not be construed to unduly limit the intended scope, spirit and extent of the invention.

### Detailed Description and Working of Preferred Embodiment I

According to the preferred embodiment the apparatus, system/s that effectively harness and efficiently convert gravitational force/energy so as to generate large scale electric power comprising (without limitation and more particularly, to provide a simplistic example and explanation) three identical units wherein; each single unit comprises; (i) A first hollow vertical cylindrical channel, 48 meters in height, inner diameter of 1 meters 30 cms, and wall thickness of 50 cm, erected above ground level, provided with at least two guide rails along its inner walls through which (ii) a Main-weight comprising (ii)(a) an upper component called the Head made of preferably (but not limited to) Titanium 30 cm in height, weighing 500 kg, diameter 1 m, cylindrical in shape, corresponding to the cross section of the channel and provided with rollers at its periphery, that conform with and slide through and along the said guide rails of the said vertical channel, and (ii)(b) a lower component being a vertical shaft preferably made of (but not limited to) Titanium 45 meters in length, and weighing 100 kg per meter of height,=4500 kgs in weight, and which bears teeth on one side along 40 meters, i.e., from top 5^{th} to bottom 44^{th} meter of its length that engage a main gear with a perimeter of 1 meter, that in turn directly rotates the Horizontal shaft of 0.96 meter radius of a generator, as the said vertical shaft moves downward with the falling Main weight due to the gravitational force at a velocity of 3 mtrs/sec=13.3 seconds for a fall of 40 meters, i.e., having due regard to the atmospheric air resistance, and the impedance offered by the gear on the Horizontal shaft that it is meshed with and rotates. The upper said component or Head (ii)(a) of the main weight is preferably (but not limited to) cylindrical, or cylindrical-oval, square-prism or such other shape corresponding to the said first hollow vertical channel and depending on specific requirements of a project. For instance, where the project caters to large scale electricity generation wherein very heavy and large weight is used, it is preferable to use cylindrical, oval or square prism shape in order to accommodate a larger number of ropes to suspend the said weight. The said Main gear acts as a free wheel so as to permit bi-directional engagement and uni-directional rotation i.e., when the said vertical shaft moves downward.
(a) As the said Main weight makes a downward freefall under the influence of gravity, its upper component or Head reaches the bottom of the hollow vertical channel where it is gradually halted with the help of—a combination of Air Chamber/s, Air Pusher/s, spring/s, Brakes, Electromagnet/s, as well as by the Opposing movement of the Counterweight on the other side, and the Vertical shaft being the lower component of the said Main weight enters a vertical subterranean hollow tube 45 meters in depth.

The said weight is suspended by heavy duty: 24 mm traction ropes made up of (but not limited to) self lubricated fibre synthetic traction ropes, from a system of pulleys wherein the other ends of the said ropes are attached to (iii) a Counterweight, which is mounted on a lift such that the said lift (along with the said counterweight) is suspended to slide upward and downward in a vertical frame erected parallel to the said hollow vertical channel, such that the direction of movement of the Main weight is opposite that of the counterweight which according to this embodiment is marginally heavier than the main weight, i.e, 5100 Kg.

The Counterweight that more or less balances the main weight is mounted on a powered Lift system to carry it upwards and downwards at predetermined speeds to synchronize the falling weight such that revolution of the horizontal shaft of the generator is kept constant. The said lift is powered by a 20 HP motor which lifts the counterweight at 45 meters in 15 seconds, whereby the energy required is 12 KW in 15 seconds. Hence in this embodiment comprising 3 units, the total power consumed by the 3 lifts is (12 kw×4×60×24)=69 MW in a day. The main weight and counterweight of each unit are suspended by a set of 9 heavy duty 24 mm traction ropes.

The said ropes in each unit run along a system of Pulleys; each system comprising 12 rows of pulleys and hence a total of 36 pulleys are employed in this embodiment comprising 3 units. Each pulley is made of manganese bronze and has a diameter of 50 cm. Each system of Pulleys is designed to provide for auxiliary power generation so as to allow for mounting coils/magnets to produce electricity.

The synchronisation of upward-downward movements of the main weight and counterweight is executed with the help of Magnetic sensor/s which is placed at a distance of 40 meters from the apex of the first vertical channel, to control the velocity of the counterweight and hence that of the main weight.

When the Head of the said Main-weight reaches the bottom of the first hollow Vertical channel at 40 meters depth, the Magnetic Sensor in Unit I will activate an Electronic Signal in the Lift of Unit I to exert necessary retarding effect by means of brakes or motion in the same direction as the Main weight of Unit I, thereby first controlling/retarding the fall of the said Main weight, and subsequently setting it in motion in the opposite direction to travel back upwards to its original position.

The said Sensor in Unit I, will also activate an Electronic signal in the Lift in Unit II to commence the free falling phase of the Main weight in Unit II. This cycle is repeated by the Magnetic Sensor in Unit II, in tandem, in order to signal to activate the Lift in Unit III to commence the free falling phase of the Main weight in Unit III, and likewise the cycle repeats for the Magnetic Sensor in Unit III, in tandem, in order to signal to activate the Lift in Unit I to commence the free falling phase of the Main weight in Unit I, thereby ensuring that at least one vertical shaft (of one of the 3 Units) will be in its descending/dropping phase at any given time.

### The Process/Method of Generation of Power/Electricity

### Start-Up

(a) According to this embodiment, since the Counterweight is heavier than the Main weight, the default position before start-up would be; the Main weight raised up at 45.5 meters height in the first vertical hollow channel and the Counterweight (along with the lift) stationed at the bottom of the vertical frame. The start-up operation would therefore involve, among others, operating the said Lift in an upward direction to cause the main weight to drop. This process step consumes the higher input power/energy particularly at the beginning of this step since the direction of movement of the Lift (along with the Counterweight) is against gravity, but as the Lift moves upward the burden on it is merely the difference between the weights of the Main weight and the Counterweight which is not more than 10% of the falling weight. Moreover, as the falling weight gains momentum under the influence of gravity it accelerates steadily whereby its velocity tends to increase linearly and the distance covered in unit time tends to increase quadratically. It is during this phase that maximum work is done by gravity which is harnessed by engaging the Vertical shaft of the Main weight to engage the Horizontal shaft of the generator to rotate. However, as the Main weight drops and reaches the bottom, it is gently retarded and halted by a retarding and halting mechanism comprising (but not limited to) brakes and Opposing movement of the Lift (along with the Counterweight) on the other side.

### Routine Operation

(b) In the next step (i.e., after the Main weight drops), the Lift (along with the Counterweight) which stands hoisted at the upper end of the vertical frame, is triggered by the sensor and signalling mechanism as explained hereabove, to commence downward movement. This downward movement consumes minimal power/energy for two reasons, (i) since the total weight of the Counterweight (along with the Lift) is greater than that of the Main weight on the other side, and (ii) this downward movement is along the direction of, (and is therefore additionally aided by) gravity. In embodiments comprising greater number of such units, this step can be executed even without running the lift on power since the heavier Counterweight would automatically overweigh the Main weight and lift it back up.
(c) The sensor and signalling mechanisms synchronise with the movement and direction of the Lift along with the Counterweight to ensure that at least one vertical shaft (of one of the 3 Units) will be in its descending/dropping phase at any given time to maintain constant RPM of the Horizontal shaft of the generator.
(d) This embodiment can therefore generate net power output in the range of at least 562 MW per day (having regard to 30% of power input consumed to sustain the upward-downward movement of the Main weight and Counterweight.
(e) The ideal configuration for a plant would therefore be based on the quantum of power requirement, to optimise the number of units employed, with the distance and speed of the free fall of the object/s with heavy mass, whereby upward or downward movement of either the Main weight or the Counterweight in any given unit is passive and entirely driven by gravity alone, so as to achieve minimal input of power and superlative efficiency.

### Embodiment II

In another embodiment, the input power requirements can be further minimised wherein all other conditions, parameters being the same as in the preferred embodiment I detailed above, the distinguishing features are;
(i) The System of Pulleys positioned horizontally above the vertical chamber and frame are connected to one or more motors powered either by an external source or by a part of the output power generated by this invention, so as to rotate in clock-wise and/or anti-clock wise direction to lift or drop the Main weight or Counterweight, as the case may be, either in addition to the said lifts as mentioned in embodiment I above or without the use of any lift.
(ii) In this embodiment, the means that run over the said pulleys and that suspend the weights need to exert sufficient friction and grip over the pulleys so as to pre-empt slipping. A good alternative to the said ropes as mentioned in the preferred embodiment I is (but not limited to) belts of suitable material known in the art, provided with teeth that mesh with the teeth of the said pulleys that are suitably modified to resemble gears with teeth to correspond to those in the said belts.
(iii) In this embodiment therefore the Main weight and Counter weight are preferably equal in mass and weight and hence, once the weights are set in motion by the rotating pulleys, a mere fillip is sufficient to accelerate the drop of the Main weight, thereby conserving input power and enhancing out put efficiency.

### Embodiment III

In another embodiment, the input power requirements can be further minimised wherein all other conditions, parameters being the same as in the preferred embodiment I detailed above, the only distinguishing features are;
(i) The Main weight and Counterweight are exactly equal,
(ii) Each Main weight and Counterweight is further attached to an Upper lift (that positioned above the respective weight (i.e., Main weight or Counterweight) and a Lower lift positioned below the respective weight (i.e., Main weight or Counterweight) and wherein each of the said Upper and Lower lifts is detatchable from its respective weight.
(iii) The sensor and signalling mechanisms, based on a calculation that rationalises and optimises the distance, speed/velocity, and number of units in the system, govern the programmed attachment and detachment of the said lifts from their respective counterweights.
(iv) Each of the said lift has its own mass and weight which is constant across lifts in a given unit.
(v) When a given lift attaches itself to its respective weight, while another lift detaches itself from its respective weight a disequilibrium or imbalance is brought about, which in turn causes the weight from which one or both lifts are detached to get automatically hoisted as the weight on the other side with both its respective lifts attached to it and therefore being heavier to drop, either freely under the influence of gravity or due to the powered movement of the respective lift/s.
(vi) This upward and downward movement, leverages gravitational force to the maximum and thereby minimises the requirement of input power so as to achieve superlative power generative efficiency of the system.

1-19. (canceled)

20. A system for converting gravitational energy into kinetic energy, the system comprising:
energy converting means for converting gravitational energy generated by the free fall of the main weight into kinetic energy, the energy converting means comprising a main gear; and
at least one unit, each unit comprising:
a main weight adapted to be engaged in a free fall along a free fall acceleration direction between an upper elevation position and a lower elevation position; and
a vertical shaft adapted to extend downward from the main weight along the free fall acceleration direction for being induced in the free fall along with the main weight, the shaft having a longitudinal axis and a lateral wall along the longitudinal axis adapted to engage and rotate the main gear as the main weight is free falling between the upper elevation position and the lower elevation position.

21. The system as claimed in claim 20, wherein the upper elevation position and the lower elevation position define a free-fall height, and wherein the vertical shaft has a length equal or greater to the free-fall height.

22. The system as claimed in claim 21, wherein the main gear is located in proximity of the lower elevation position.

23. The system as claimed in claim 22, wherein the vertical shaft extends along the free fall acceleration direction between the main weight and the main gear for engaging and rotating the main gear at all times during the free fall of the main weight.

24. The system as claimed in claim 23, wherein the lateral wall of the vertical shaft comprises shaft teeth and the main gear comprises gear teeth, the shaft and gear teeth being adapted to mesh together to enable the main gear to rotate according to a rotation axis perpendicular to the free fall acceleration direction as the main weight is in free fall between the upper elevation position and the lower elevation position.

25. The system as claimed in claim 24, wherein the vertical shaft teeth are located along the lateral wall of the shaft in such as manner that the shaft teeth engage with the gear teeth only after the free fall of the main weight has been triggered in order to avoid friction with the gear teeth while the main weight is still in a stationary position.

26. The system as claimed in claim 25, wherein the main weight and vertical shaft are integral.

27. The system as claimed in claim 26, wherein the main weight has a first center of gravity and the vertical shaft has a second center of gravity corresponding to the first center of gravity.

28. The system as claimed in claim 27, wherein each unit further comprises retarding and halting means for retarding and halting the main weight in proximity of the lower elevation position.

29. The system as claimed in claim 28, wherein the retarding and halting means comprise at last one of an air chamber, an air pusher, springs, brakes, electromagnets, opposing movement of the counterweight.

30. The system as claimed in claim 29, wherein the retarding and halting means are located in proximity of the lower elevation position.

31. The system as claimed in claim 30, wherein each unit further comprises:
a first vertical channel adapted to extend along the free fall acceleration direction between the upper and lower elevation positions and adapted to receive and guide the main weight and the vertical shaft along the free fall acceleration direction between the upper and lower elevation positions.

32. The system as claimed in claim 31, wherein the first vertical channel comprises guide rails and rollers adapted to enable the main weight to slide inside the channel in the free fall acceleration direction between the upper and lower elevation positions.

33. The system as claimed in claim 32, wherein the first vertical channel has a cross-section corresponding substantially in shape to the cross-section of the main weight.

34. The system as claimed in claim 33, wherein the energy converting means further comprise a horizontal shaft and a free wheel in cooperation with the main gear, wherein the horizontal shaft is adapted to extend along the rotational axis of the main gear and to rotate in a rotational direction when the vertical shaft engages and rotates the main gear while moving downwardly in the free fall acceleration direction during the free fall, and wherein the free wheel is adapted to prevent the horizontal shaft of rotating in a direction opposite to the rotational direction when the vertical shaft engages the main gear while moving upwardly against the free fall acceleration direction.

35. The system as claimed in claim 34, wherein each unit further comprises a hollow tube adapted to be located below the vertical channel along the free fall acceleration direction for accommodating the vertical shaft as the main weight falls from the upper elevation position to the lower elevation position.

36. The system as claimed in claim 35, wherein the tube is subterranean.

37. The system as claimed in claim 35, wherein the main weight and the vertical shaft are made of a material of a suitable mass and density.

38. The system as claimed in claim 37, wherein the material comprises titanium.

39. The system as claimed in claim 38, wherein the main weight is substantially circular in shape and has a diameter of at least 1 meter.

40. The system as claimed in claim 39, wherein the vertical shaft is at least 45 meters in length and has a weight of around 100 Kg per meter of length.

41. The system as claimed in claim 40, wherein the weight of the vertical shaft is around 9 times the weight of the main weight.

42. The system as claimed in claim 41, wherein the mean gear is circular in shape and has a perimeter of around 1/45 the length of the vertical shaft.

43. The system as claimed in claim 20, wherein said at least one unit is at least two units, the at least two units being adapted to operate in tandem synchronization to maintain a continuous rotation of the main gear such that at least one unit is in operation at any time for engaging and rotating the main gear.

44. The system as claimed in claim 43, wherein said at least two units further comprise sensors and signaling means for ensuring said tandem synchronization between the units.

45. The system as claimed in claim 20, wherein each unit further comprising a counterweight adapted to be in counterbalance cooperation with the main weight for slowing down the main weight in proximity of the lower elevation position during the free fall.

46. The system as claimed in claim 45, wherein the main weight has a first mass and the counterweight has a second mass, wherein the cooperation between the weight and counterweight is such that the counterweight assists in lifting the main weight from the lower elevation position to the upper elevation position such that only the difference of mass between the first and second masses needs to be worked upon by another power source.

47. The system as claimed in claim 46, wherein each unit further comprises pulleys and ropes adapted to provide the counterbalance cooperation between the weight and the counterweight.

48. The system as claimed in claim 47, wherein each unit further comprises sensors, signaling means and speedometers for controlling and synchronizing the velocity of the counterweight while in counterbalance cooperation with the main weight such that the rotation of the main gear remains substantially constant during the free fall of the main weight.

49. The system as claimed in claim 48, wherein each unit further comprises a second vertical channel adapted to extend adjacent and parallel to the first vertical channel for receiving and guiding the counterweight in an upward and downward movement.

50. The system as claimed in claim 49, wherein each unit further comprises lifting means for lifting at least one of the weight and the counterweight against the free fall acceleration direction if required.

51. The system as claimed in claim 50, wherein the lifting means are powered by an auxiliary power source.

52. The system as claimed in claim 51, wherein the counterweight is 3% to 10% heavier than the main weight.

53. The system as claimed in claim 51, wherein the counterweight is 3% to 10% lighter than the main weight.

54. The system as claimed in claim 51, wherein the weight and counterweight are of equal weight.

55. The system as claimed in claim 51, wherein said energy converting means generate electricity, and wherein the lifting means are powered at least partially by the generated electricity.

56. The system as claimed in claim 55, wherein the auxiliary power source comprises a motor adapted to provide power to the energy converting means and pulleys.

57. The system as claimed in claim 56, wherein the sensors to control and synchronize the velocity comprise at least one of magnetic sensors, light beam/laser sensors, passive infrared sensors, knock sensors, pressure sensors, proximity sensors, and electric sensors.

58. The system as claimed in claim 57, wherein the auxiliary power source comprises coils and magnets, said coils and magnets being adapted to provide an electrical network to at least one of the pulleys, the first vertical channel, the second vertical channel, the main weight, the counterweight, the converting means, the vertical shaft and the hollow tube.

59. A method of generating electricity using means for converting gravitational energy into kinetic energy comprising a main gear, the method comprising:
a) engaging a main weight in a free fall from an upper elevation position to a lower elevation position along a free fall acceleration direction, the main weight having a vertical shaft extending downwardly in the free fall acceleration direction between the main weight and the main gear, the main gear being located in proximity of the lower elevation position, such that the vertical shaft is induced in the free fall along with the main weight and engages and rotates the main gear according to an axis of rotation perpendicular to the free fall acceleration direction at all times during the free fall as the main weight falls between the upper and lower elevation positions;
b) using the kinetic energy generated by the rotation of the main gear for producing electricity.

60. The method of claim 59, further comprising:
c) counterbalancing the main weight having a first mass by a counterweight having a second mass such that only the net difference of the first and second masses is worked upon by an auxiliary power source in order to lift at least one the main weight and counterweight to its original position, along the direction of gravity or otherwise, said auxiliary power source comprising at least partially power generated by steps a) and b).

61. The method of claim 60, further comprising:
d) providing at least two units for conducting steps a) to c) such that the at least two units operate in a synchronized tandem to maintain a steady RPM of the main gear and such as at least one unit is in operation at all times.

62. The method of claim 61, wherein the energy converting means further comprise a horizontal shaft and a free wheel in cooperation with the main gear, wherein the horizontal shaft is adapted to extend along the rotational axis of the main gear and to rotate in a rotational direction when the vertical shaft engages and rotates the main gear while moving downwardly in the free fall acceleration direction during the free fall, and wherein the free wheel is adapted to prevent the horizontal shaft of rotating in a direction opposite to the rotational direction when the vertical shaft engages the main gear while moving upwardly against the free fall acceleration direction.
